(19) United States
(12) Patent Application Publication
(10) Pub. No.: US 2010/0042023 A1
(43) Pub. Date: Feb. 18, 2010

(54) CONTINUOUS PASSIVE AND ACTIVE MOTION DEVICE AND METHOD FOR HAND REHABILITATION

(75) Inventors: Edward Jung Wook PARK, Coquitlam (CA); Benjamin John BIRCH, Victoria (CA); Clifford Edmund HASLAM, Victoria (CA); Nikolai DECHEV, Victoria (CA); Imtehaze HEERAH, Victoria (CA)

Correspondence Address: MILLER NASH LLP, 601 UNION STREET, SUITE4400, SEATTLE, WA, 98101-2352, US

(73) Assignee: SIMON FRASER UNIVERSITY, Burnaby (CA)

(21) Appl. No.: 12/539,565

(22) Filed: Aug. 11, 2009

Related U.S. Application Data
(60) Provisional application No. 61/087,912, filed on Aug. 11, 2008.

(51) Int. Cl. A61H 1/02

(52) U.S. Cl. 601/40

(57) ABSTRACT

A hand rehabilitation device includes a hand support assembly and a drive mechanism. The hand support assembly being movable to flex and extend the metacarpophalangeal and proximal interphalangeal joints of a user's hand independently.

### TECHNICAL FIELD

The present technology relates to a device to assist in hand therapy. More specifically, it relates to a device that provides for both continuous passive and continuous active motion therapy

### BACKGROUND

Currently most active hand rehabilitation exercises are done with putty, resistance webs, squeeze balls, grip strengtheners and other purely mechanical devices. In general, these types of devices are only capable of providing a single level of resistance and are not capable of isolating the metacarpophalangeal (MCP) and proximal interphalangeal (PIP) joints of the hand. In addition, these types of devices do not provide any external feedback so it is difficult for a therapist to monitor a user's progress.

The dorsal-mounted CyberGrasp™ device, which is manufactured by VRLOGIC GmbH, and the Rutgers Master II-ND™ haptic glove, which is palm-mounted, both provide external feedback, however both devices have limitations when used in hand rehabilitation applications.

### SUMMARY

In one aspect of the invention, there is provided a hand rehabilitation device including: a drive mechanism provided in a housing, the drive mechanism including a first motor coupled to the housing and a second motor, the first motor and the second motor being independently operable; and a hand support assembly for receiving a hand of a user, the hand support assembly being coupled to the housing and comprising a first rotatable joint provided between a stationary arm and a first link and a second rotatable joint provided between the first link and a second link, the first link being rotatable about the first rotatable joint by the first motor and the second link being rotatable about the second rotatable joint by the second motor, the second motor being coupled to the first link and rotatable about the first rotatable joint; wherein the first rotatable joint is for alignment with a metacarpophalangeal joint of the hand of the user and the second rotatable joint is for alignment with a proximal interphalangeal joint of the hand of the user.

In another aspect of the invention, there is provided a hand rehabilitation apparatus including: a hand rehabilitation device including: a drive mechanism provided in a housing, the drive mechanism including a first motor coupled to the housing and a second motor, the first motor and the second motor being independently operable; and a hand support assembly for receiving a hand of a user, the hand support assembly being coupled to the housing and comprising a first rotatable joint provided between a stationary arm and a first link and a second rotatable joint provided between the first link and a second link, the first link being rotatable about the first rotatable joint by the first motor and the second link being rotatable about the second rotatable joint by the second motor, the second motor being coupled to the first link and rotatable about the first rotatable joint; a computer in communication with the hand rehabilitation device, the computer including a processor for calculating haptic forces based on a position of the first link and the second link and outputting torques to the hand rehabilitation device, the torques being applied to the first rotating link and the second rotating link by the first motor and the second motor; and a display in communication with the computer, the display for displaying a visual representation of the hand of the user; wherein the haptic forces are determined based on a rehabilitation mode.

### DRAWINGS

The following figures set forth embodiments of the invention in which like reference numerals denote like parts. Embodiments of the invention are illustrated by way of example and not by way of limitation in the accompanying figures.

FIG. 1 is a graph depicting a minimum jerk trajectory model compared to user data in the case of PIP joint;

FIG. 2 is a perspective view of a hand rehabilitation device according to an embodiment of the invention;

FIG. 3 is a schematic side view of the hand rehabilitation device of FIG. 2;

FIG. 4 is a perspective view of the hand rehabilitation device of FIG. 2 including a user's hand;

FIG. 5 is a top view of the hand rehabilitation device of FIG. 2 including a user's hand with the MCP (metacarpophalangeal) joints flexed;

FIG. 6 is a top view of the hand rehabilitation device of FIG. 2 including a user's hand with the PIP (proximal interphalangeal) joints flexed;

FIG. 7 is a top view of the hand rehabilitation device of FIG. 2 including a user's hand with the MCP and PIP joints flexed;

FIG. 8 is a block diagram of a hand rehabilitation apparatus including the hand rehabilitation device of FIG. 2;

FIG. 9 is a method of operation of the hand rehabilitation apparatus of FIG. 8;

FIG. 10 is a screen shot of a display of the hand rehabilitation apparatus of FIG. 8;

### DETAILED DESCRIPTION OF EMBODIMENTS OF THE INVENTION

The hand rehabilitation device 10 described herein allows the metacarpophalangeal (MCP) and proximal interphalangeal (PIP) joints of the hand to be controlled independently and is able to determine both the position and torque of the joints. In a passive mode, the hand rehabilitation device 10 attempts to move the joints such that the movement follows a joint trajectory path that closely approximates natural human hand motion. To achieve this, the natural human hand's joint motions were measured. Each of three healthy volunteers was outfitted with six light emitting diode (LED) markers recognized by a Visualeyez™ optical motion tracking system (from PhoeniX Technologies Inc.). The markers were placed on the back of the volunteer's middle finger as follows: two on the back of the hand, two on the finger between the MCP and PIP and two on the finger between the PIP and DIP. This way each group of two sensors could be used to determine the vector corresponding to that bone or part of the hand and thus the MCP and PIP angles can be calculated.

The volunteers were then asked to perform a series of four hand motions typically used during hand rehabilitation, five repetitions for each motion. The data from these tests was compiled and the joint angles of the PIP and MCP were calculated for each time step. This produced the angles for the MCP and the PIP. Data for five consecutive time steps was averaged to account for minor fluctuations in the data.

Next, the test data was compared to the minimum Jerk model [N. Hogan (1984), “An Organizing Principle for a Class of Voluntary Movements”, Journal of Neuroscience, 4, pp. 2745-2754.] in order to determine if the model can approximate human hand motion accurately. Jerk, which is the time derivative of acceleration, is a universally accepted quantity of evaluating motor smoothness of human limbs. If we apply minimum jerk theory to the motion of the natural finger joints, each joint should move smoothly from one position to another following a joint trajectory that minimizes the sum of the squared jerk, i.e.

$$minimize J = \frac{1}{2} {\int }_{{t}_{i}}^{{t}_{f}} {{θ}^{⃛} ( t )}^{2} d t \qquad ( 1 )$$

Where {umlaut over (\dot{θ}(t) is the jerk of the joint trajectory θ(t). If we set the initial and final resting joint positions as θᵢ and θ_{f}, respectively, and if the joint moves between these two positions in time D(=t_{f}−tᵢ), the minimum jerk trajectory is obtained:

$$θ ( t ) = {θ}_{i} + ( {θ}_{f} - {θ}_{i} ) ( 10 {( \frac{t}{D} )}^{3} - 15 {( \frac{t}{D} )}^{4} + 6 {( \frac{t}{D} )}^{5} ) \qquad ( 2 )$$

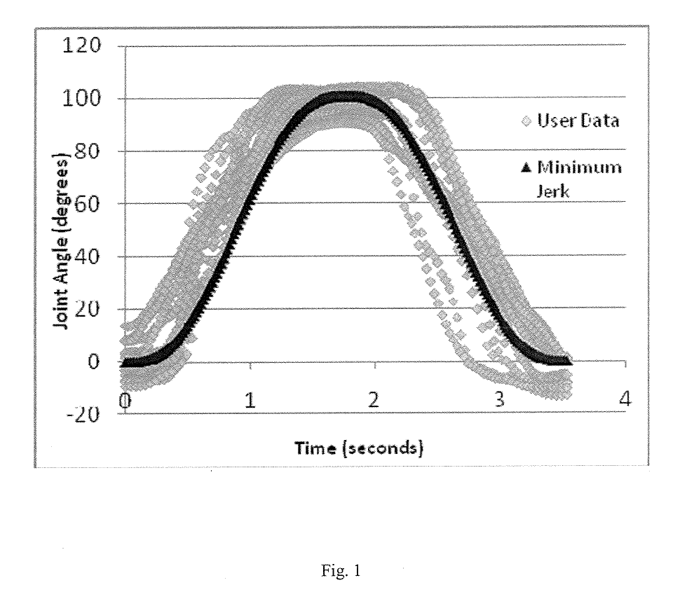

Next, the above minimum jerk trajectory model was compared to the Visualeyez data by inputting the average duration and average maximum joint angle from the users into Eq. (2) and plotting the results. FIG. 1, which is a representative case, shows that the natural PIP flexion motion indeed follows a very similar trajectory to that of the minimum jerk model. Hence, the model was deemed acceptable and subsequently implemented in the proposed device in guiding the passive motions. The model is adaptable as it can be tailored to match the needs of the patient (i.e. per-user bases) by adjusting the maximum ROM and the duration of the motion.

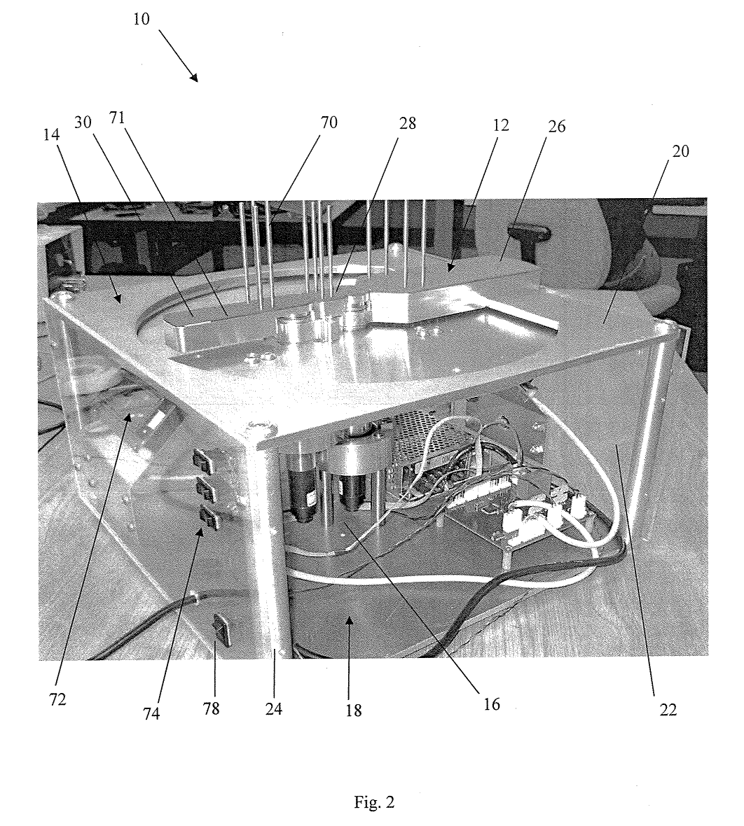

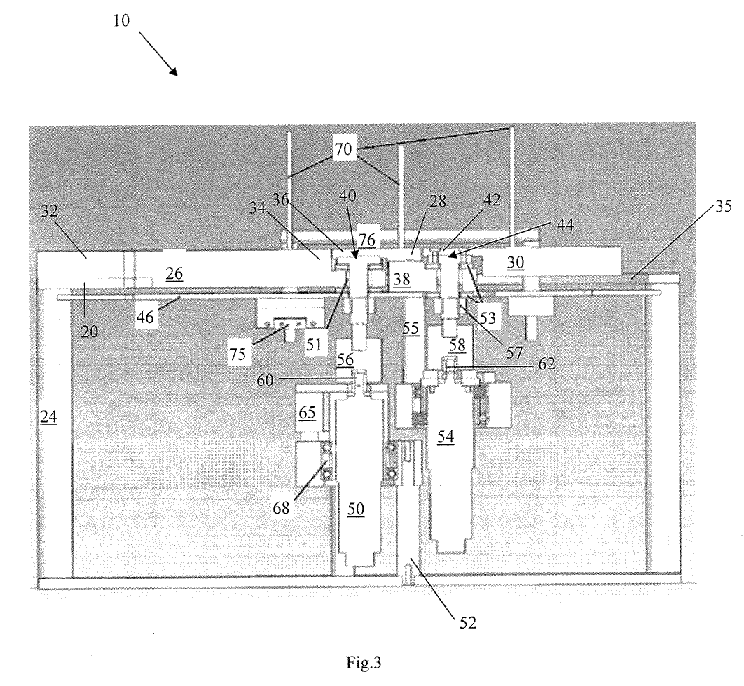

Referring now to FIG. 2, a hand rehabilitation device 10 capable of controlling the MCP and PIP joints of the hand independently is generally shown. Referring also to FIG. 3, the hand rehabilitation device 10 includes: a hand support assembly 12, which is coupled to a cover 20 of a housing 14 and a drive mechanism 16, which is provided inside the housing 14. The housing 14 includes a base 18, cover 20 and sidewalls 22. The cover 20 is spaced from the base 18 by four posts 24. As shown, the base 18 and cover 20 are generally square in shape and the posts 24 are provided at the corners thereof.

The base 18, cover 20 and posts 24 are made of stainless steel or another suitable material and the sidewalls 22 are made of Plexiglass or another suitable material. It will be appreciated by a person skilled in the art that although the housing 14 of the hand rehabilitation device 10 is shown as being generally cube-shaped, it may be another suitable shape.

The hand support assembly 16 includes a stationary arm 26, a first link 28, an extension 38, which is coupled to the first link 28, and a second link 30. A first end 32 of the stationary arm 26 is coupled to the cover 20 of the housing 14 and a second end 34 of the stationary arm 26 is suspended above an opening 35 that is provided in the cover 20. A first end 36 of the first link 28 is coupled to the second end 34 of the stationary arm 26 by a first rotatable joint 40. A first end 42 of the second link 30 is coupled to extension 38 of the first link 28 by a second rotatable joint 44. The first rotatable joint 40 and the second rotatable joint 44 allow in-plane rotation of the first link 28 relative to the stationary arm 26 and the second link 30 relative to the first link 28, respectively.

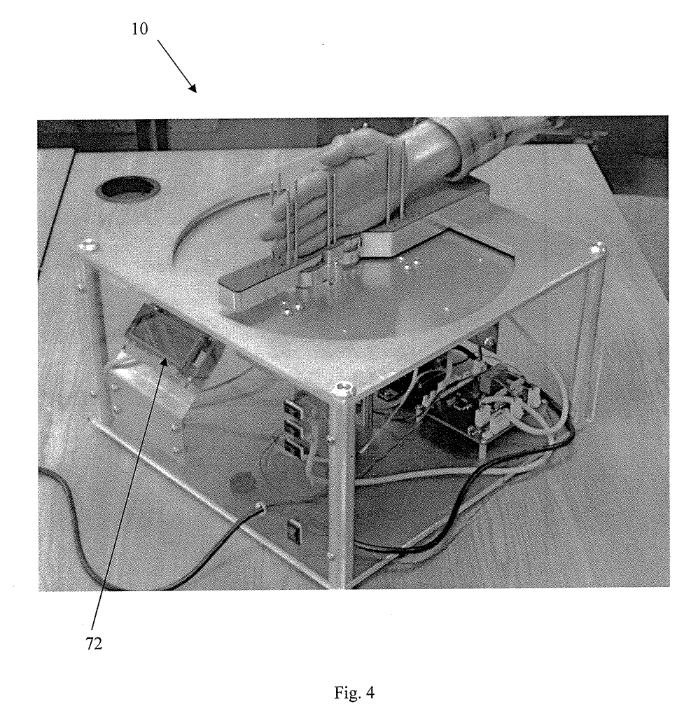

As shown in FIG. 4, when a user's hand is received in the hand rehabilitation device 10, the MCP joint of the user's hand is aligned with the first rotatable joint 40, the PCP joint of the user's hand is aligned with the second rotatable joint 44, the proximal segment of the fingers between the MCP and the PIP joints rests on the first link 28 and the distal and middle segments of the fingers rest on the second link 30. This arrangement allows the hand rehabilitation device 10 to operate the MCP and PIP joints independently enabling intrinsic minus, intrinsic plus and fist motions of the hand. Further, the first rotating joint 40 and the second rotating joint 44 have a range of −90° to +90°, which allows the device 10 to be used with either hand.

The drive mechanism 16 includes a first motor 50, which is coupled to the base 18 by first motor support posts 52, and a second motor 54 that is coupled to the extension 38 by second motor support posts 55. The first and second links 28, 30 of the hand support assembly 12 are coupled to drive shafts 60 and 62 of the first motor 50 and second motor 54 by couplers 56 and 58, respectively, and a pair of thrust bearings 53, a lock nut 57 and a needle roller bearing 51. The first motor 50 rotates the first link 28 and the second motor 54, which is coupled to the first link 28 via the extension 38, about the first rotatable joint 40. The second motor 54 rotates the second link 30 about the second rotatable joint 44. The second rotatable joint 44 is a floating joint because the location of the second motor 54 and its drive shaft 62 rotates about the first rotatable joint.

The first and second motors 50, 54 are MicroMo DC motors with 246:1 planetary gear heads that provide the hand rehabilitation device 10 with a maximum torque of 4.5 Nm, which is the torque rating on the motor's gear head. A person skilled in the art will appreciate that this torque is sufficient for both active and passive exercises. Standard rehabilitation grip mechanisms, such as Digi-grip™, for example, offer a maximum of 9 lbs for rehabilitation, which when converted to a torque on the first rotating joint 40, corresponds to approximately 2 Nm. Other types of motors having a suitable torque may alternatively be used.

Pins 70 are removably received in bores 71, which can be seen in FIG. 2, that are provided in the stationary arm 26, the first link 28, the extension 38 and the second link 30 of the hand support assembly 12. The pins 70 are provided to maintain the user's hand in contact with the hand support assembly 12 during use of the hand rehabilitation device 10. The pins 70 generally define a hand-receiving cavity and may be adjusted in position, to adapt to various hand sizes. Multiple bores 71 are provided in the stationary arm 26, first link 28, extension 38 and second link 30 in order to allow the pins 70 to be positioned at different locations along the length and width of the hand support assembly 12 for accommodating different hand sizes. The pins 70 are made of stainless steel and are padded to comfortably contact the user's hand. In the embodiment shown in FIG. 2, twelve pins 70 are provided with three sets of four pins being received at proximal, middle and distal locations along the hand support assembly. It will be appreciated by a person skilled in the art that more or fewer pins 70 may be used and that the pins 70 may be made of any suitable material.

The extension 38 of the first link 28 allows the distance between the first rotatable joint 40 and the second rotatable joint 44, which corresponds to the distance between the user's MCP and PIP joints, to be adjusted so that the hand rehabilitation device 10 may be used with different hand sizes. The extension 38 is slidable relative to the first link 28 by removing the middle set of pins 70. When the proper distance is reached, the middle set of pins 70 are re-inserted through the bores (not shown) provided in the first link 28 and the bores (not shown) provided in the extension 38 to lock the parts together. The second motor 54 is coupled to the extension 38 of the first link 28 so that when the extension 38 slides, the second motor 54 and second link 30 move with the extension 38.

A guard 46 is provided between the hand support assembly 12 and the drive mechanism 16 to separate the hand support assembly 12 and the drive mechanism 16. The guard 46 generally covers the opening 35, which is provided in the cover 20 of the housing 14.

The first and second motors 50, 54 are each provided with two sensors 65 that detect the torque acting on the motor case 64, 66 relative to the motor drive shaft 60, 62. The first and second motors 50, 54 are each mounted in double ball bearing sets 68, which constrain the motors 50, 54 in all directions except for rotation about their shafts 60, 62. The torque is determined by detecting the reaction force developed by each motor case 64, 66 as it presses against the sensors 65. The sensors 65 are piezoresistive sensors that decrease in resistance with the force applied thereto. The motor current is also measured in order to obtain an independent torque estimate.

The sensors 65 are FlexiForce™ sensors, which are manufactured by Tekscan, and are capable of reading up to 6.74 Nm. It will be appreciated by a person skilled in the art that another suitable type of sensor may alternatively be used.

An integrated magnetic encoder is provided to measure the position of the first and second links 28, 30. The encoder is a quadrature reporting magnetic encoder that is coupled to the motor shaft 60, 62 and located at the bottom of the motor assembly. The encoder is supplied as an accessory to the MicroMo DC motors 50, 54 that are provided in an embodiment of the hand rehabilitation device 10. The quadrature signals, clock and direction, connect to circuitry that reduces the number of reported pulses per rotation from 512 to 16 and the reduced pulse rate is sent to a microcontroller (not shown) of the hand rehabilitation device 10. The encoder is an incremental encoder meaning that it measures motor rotation relative to an initial starting point, rather than an absolute position of the motor 50, 54 at any given time. The microcontroller functions to count the signal pulses from the rotary encoders by incrementing/decrementing a software position variable to calculate an absolute motor position. Thus from a known initial position (calibrated off the extreme range of motion of the device) counts received form the encoders can be used to determine the position of the device.

The microcontroller (not shown) of the hand rehabilitation device 10 monitors the position and torque of each motor 50, 54 and generally controls the hand rehabilitation device 10. The microcontroller may be programmed with C code or another suitable programming language.

The user interface of the hand rehabilitation device 10 includes three input switches 72, an on-off switch 78, an emergency stop switch (not shown) and LCD displays 74. The switches 72 shown in FIGS. 2 and 4 are rocker switches, however, another type of switch may be used. Two displays 74 are provided on opposite sides of the housing 14 and display the same information so that both the user and the therapist may easily view the information. The input switches 72 are used to enter values such as a time or a desired torque. This is accomplished by using one switch for enter and back, one for selecting the digit and one to increment and decrement the number.

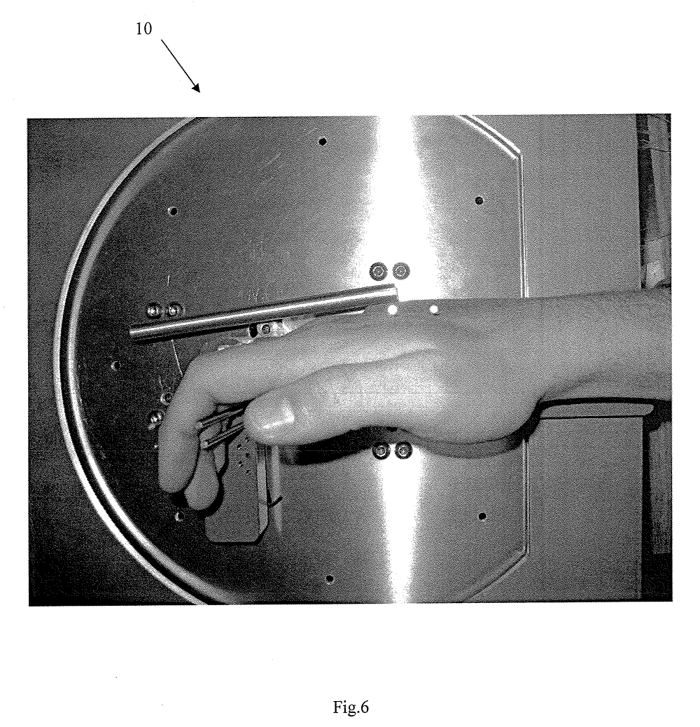

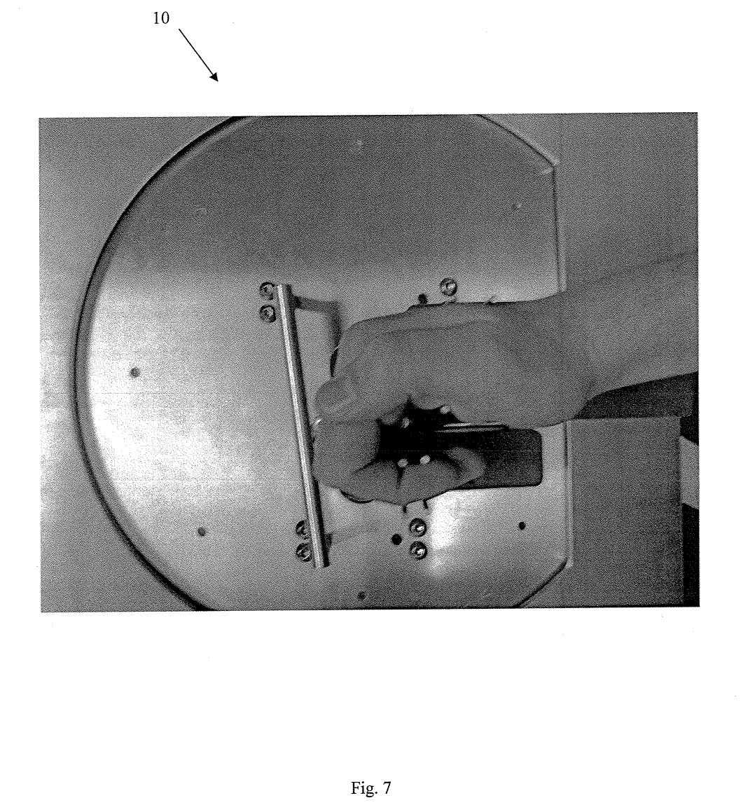

The hand rehabilitation device 10 includes several safety features for ensuring that the drive mechanism 16 operates correctly based on which hand is received in the device 10. A mechanical stop 76, which can be seen in FIGS. 3, 5, 6 and 7, is coupled to the guard 46 to restrict the first and second links 28, 30 from moving beyond a neutral position and hyper extending the user's hand. An optical switch 75 ensures that the mechanical stop 76 is in use and further determines which side the mechanical stop 76 is on so that the motors 50, 54 do not drive towards the mechanical stop 76.

In use, the hand rehabilitation device 10 is placed on a table top or on another stable surface. As shown in FIG. 4, the user first places his/her hand on the hand support assembly 12 between the pins 70 adjusting the width of the cavity defined by the pins 70, if appropriate. The user then aligns his/her MCP joint with the first rotating joint 40, removes the pins 70 that lock the extension 38 in place and slides the extension 38 until his/her PIP joint is aligned with the second rotating joint 44. Once the MCP and PIP joints are correctly located on the hand support assembly 12, the user re-inserts the pins 70 that lock the extension 38 to the first link 28.

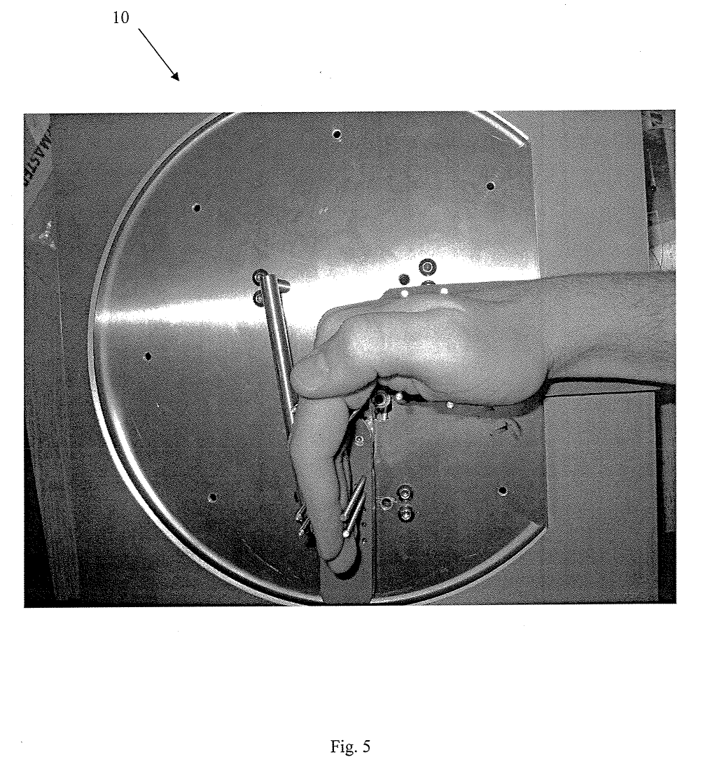

The hand rehabilitation device 10 is operable in warm-up mode, CPM (continuous passive mode) and CAM (continuous active mode). The hand may move as shown in FIGS. 5, 6 and 7 in any one of the modes. The modes were selected based on an assessment of current established rehabilitation techniques and the advice of hand therapists.

The warm-up mode is a version of the CPM mode in which the hand rehabilitation device 10 performs an ever increasing ROM. The user selects a start point and end point for the ROM (range of motion), duration for the exercise, maximum torque, and a time for a single cycle, which is used to determine the motion speed. The device 10 then travels to an increasing proportion of the selected ROM. It starts at 50% of the full ROM and by the last cycle travels 100%. The motion will follow the minimum jerk trajectory model, which has been previously discussed.

In the CPM mode, the device 10 passively (i.e. with no force from the user) moves the user's hand through a preset ROM following the minimum jerk trajectory model. There are two major differences between this and the warm-up mode. Firstly, the entire duration of the exercise runs at 100% of the selected ROM. Secondly, the motion is not simply between a single start point and end point. The ROM used in this mode is set when the user chooses a series of target positions. The device 10 cycles through the target positions sequentially following the minimum jerk path. If the user picks multiple points, for example four points, then the device will move from one to two, from two to three, from three to four, and then from four back to one again. In this way the different motions can be incorporated into one fluid motion. In one example, the user may move from a neutral position, to an intrinsic minus position, to a closed fist, to an intrinsic plus position and then back to neutral. This will allow for utilizing the full capabilities of the two-motor design.

The CAM mode of the hand rehabilitation device 10 generates a predetermined resistance to motion that is applied against the user's hand. Using the input switches 72, the user sets the start point of the exercise, the end point and the desired resistance as a torque value. Then the user attempts to move his/her hand from the start point to the end point with the device displaying a count of the number of repetitions achieved. During the motion, the sensors measure the torque produced by the user and compare it to the desired torque, thereby controlling the resistance. This enables the device 10 to produce a steady torque to resist the movement of the user from the start to the end positions. The torque is scaled up from zero to the full value over the first small deviation from the start position (10° or so) so as not to force the user back further than the start point, and to ensure that a large jerk is not applied when the user first crosses the start point. This mode simulates resistance that is typically applied by a therapist or a mechanical ball, grip strengthener, or web. The device 10 is capable of resisting both the closing and opening of the hand. This allows access to eccentric motion exercises

The selection of the starting and ending points for an exercise is handled by a ‘motion teaching’ method. This method involves specifying a starting position, by means of a button controlling each direction on the two motors, until the hand is in the desired position. Then the user presses enter and the encoder value for that position is stored in memory as the first position. The end positions are handled similarly. In this way the range of motion (ROM) is clearly apparent to both the therapist and the patient. There should be no concern that the position may have been entered incorrectly as the ROM has been visually confirmed. This ensures the machine operates with the correct hand and does not bend the wrong direction.

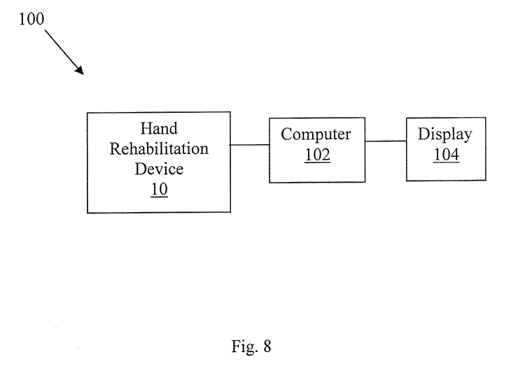

In another embodiment, the hand rehabilitation device includes a haptic rehabilitation mode. Referring to FIG. 8, a hand rehabilitation apparatus 100 including the hand rehabilitation device 10 of FIGS. 2 to 7, a computer 102 and a display 104 is generally shown. The computer 102 communicates with the hand rehabilitation device 10 and the display 104 via wires (not shown) or, alternatively, via a wireless connection. The computer 102 includes a processor (not shown) for executing software for providing haptic responses to a user, which is stored in a computer memory or another computer readable medium. The display 104 provides visual output for the user.

The hand rehabilitation device 10 continuously outputs a position of the user's joints to the computer 102, which calculates the haptic forces associated with the position of the user's hand. The haptic force values are converted to torques at the first and second rotating joints 40, 44 and transmitted to the hand rehabilitation device 10 where they are used to control motor force. This is done using torque measurement sensors 65, in conjunction with a Proportional Integral Derivative (PID) control loop to maintain the calculated desired torque level. The appropriate level for the particular rehabilitation exercise and physical condition of the user's hand is calculated based on the analysis of the required haptic forces scaled by information input by a therapist prior to the beginning of a therapy session that is performed by the software.

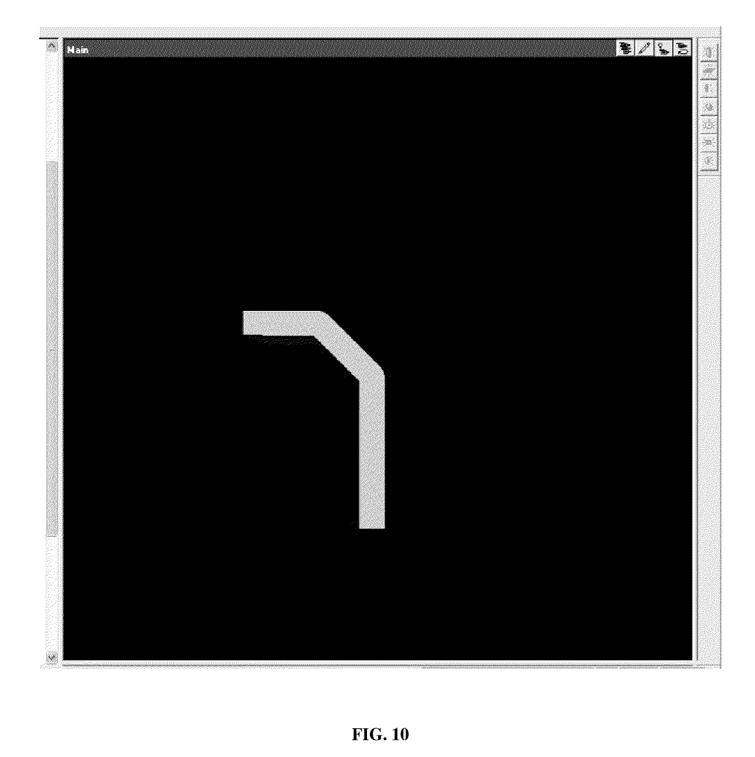

Hand position data is continuously transmitted to the computer 102 so that a visual representation of the user's hand is continuously update by the display 104. This allows the user to receive visual feedback of his/her hand position. An example of a visual representation of a user's hand is shown in FIG. 10. The reading of joint angles, reading of torque values, and comparison of torques to safety limits is done by the microcontroller of the hand rehabilitation device 10. The processor executes the software to provide the visual feedback and calculate the desired torques from the measured joint angles.

Calculated haptic forces and their corresponding torque values allow the user to experience a simulation of a rehabilitation exercise such as compressing a ball, for example. In one embodiment, the hand rehabilitation apparatus 100 mimics a hand grip strength device by simulating a spring connecting the end of the user's virtual fingers to their virtual palm. In this embodiment, the spring is displayed as part of the Virtual environment and is updated with the Virtual environment. The forces to be passed to the user are calculated based on the compression of the spring. The spring is considered to be acting only linearly with the point of contact with the palm being fixed and the point of contact to the user's fingers being fixed to the user but free to move in space. Damping is further added to the system to ensure stability.

In another embodiment, the hand rehabilitation apparatus 100 simulates a virtual ball being squeezed by a user's hand. The virtual ball is comprised of a number of radially constrained springs evenly spaced about a fixed center. Damping is included to ensure stability. The display 104 displays the boundary of the ball while the software handles the force calculations as if the ball were merely an assortment of radially constrained springs of equal spring constant. This allows the interactions to be simply modeled without the need for FEA analysis while still offering a realistic feeling for the user.

The microcontroller controls initialization of the hand rehabilitation device 10, the selection of the desired rehabilitation mode and the interface for entering any variables before starting a particular exercise. All communications between the microcontroller and the computer 102 are handled through a 28800 baud, 8 bit serial communication with no parity. In general, calculations for the haptic modes are performed by the computer 102.

The haptic mode of the hand rehabilitation device 10 allows the device 10 to simulate common activities done during current hand rehabilitation programs. The use of grip strength devices and balls of varying compression resistance is very common when a patient is regaining the full functionality and strength in their hand.

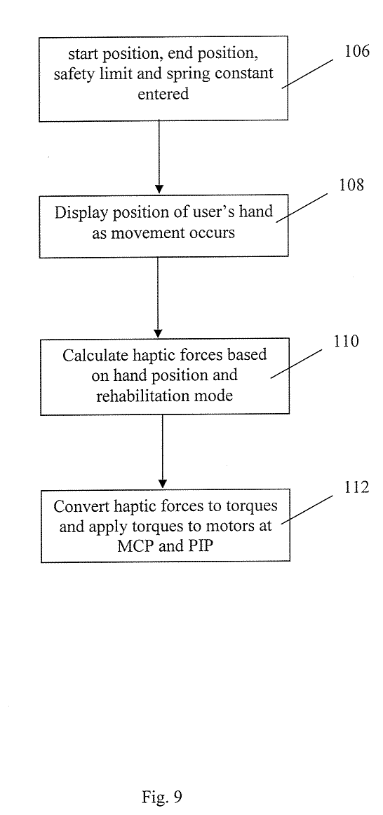

Operation of the haptic mode of the hand rehabilitation device 10 will now be described with reference to FIG. 9. At step 106, the start position, end position, safety limit (as percentage), and spring constant (as percentage) are entered by the user, or hand therapist, to produce the appropriate level of resistance. As the user moves through the range of motion from an open hand to a closed fist, the virtual spring compresses and the display 104 shows a real time model of the user's hand, as indicated at step 108, while calculating the virtual forces which would be expected from the spring at the current position and compression, as indicated at step 110. At step 112, these forces are then converted to torques at the two joints and passed to the hand rehabilitation device 10. The hand rehabilitation device 10 then uses a PID control loop to supply those torques to the user.

The hand rehabilitation apparatus 100 may be used in place of a number of hand strengthening tools. The apparatus 100 provides repeatability and allows for more control by the therapist while providing feedback. Often, users find it is easier to determine what motion is requested of them with visual cues as to the desired motion. Both the user and the therapist are likely to feel comfortable with the apparatus 100 because as it closely resembles techniques and devices, such as grip strength devices, for example, that are already in use. Further, the haptic feedback and visual display promote a greater connection between the user and the task they are performing, which often increases patient motivation.

It will be appreciated by a person skilled in the art that although the springs have been described as being linear in the haptic rehabilitation mode, non-linear springs may alternatively be used in order to provide a spring force that is stronger at the initial compression without being too strong during complete compression.

Specific embodiments have been shown and described herein. However, modifications and variations may occur to those skilled in the art. All such modifications and variations are believed to be within the scope and sphere of the present invention.

1. A hand rehabilitation device comprising:
a drive mechanism provided in a housing, said drive mechanism comprising a first motor coupled to said housing and a second motor, said first motor and said second motor being independently operable; and
a hand support assembly for receiving a hand of a user, said hand support assembly being coupled to said housing and comprising a first rotatable joint provided between a stationary arm and a first link and a second rotatable joint provided between said first link and a second link, said first link being rotatable about said first rotatable joint by said first motor and said second link being rotatable about said second rotatable joint by said second motor, said second motor being coupled to said first link and rotatable about said first rotatable joint;
wherein said first rotatable joint is for alignment with a metacarpophalangeal joint of said hand of said user and said second rotatable joint is for alignment with a proximal interphalangeal joint of said hand of said user.

2. A hand rehabilitation device as claimed in claim 1, wherein said stationary arm is coupled to a cover of said housing and said first link and said second link communicate with said drive mechanism through an opening in said housing

3. A hand rehabilitation device as claimed in claim 1, comprising an extension for adjusting a length of said first link to adjust a distance between said first rotatable joint and said second rotatable joint.

4. A hand rehabilitation device as claimed in claim 3, wherein said extension is slidable along a length of said first link, said second motor being coupled to said extension, said extension being lockable relative to said first link by pins.

5. A hand rehabilitation device as claimed in claim 1, comprising pins receivable in bores provided in said stationary arm, said first link and said second link, said pins for maintaining said hand of said user in contact with said hand support assembly.

6. A hand rehabilitation device as claimed in claim 5, wherein multiple bores are provided and said pins are movable to any of said multiple bores adjust to different sizes of user hands.

7. A hand rehabilitation device as claimed in claim 6, wherein a number of pins is twelve with six pins being provided on each side of said hand of said user to define a hand-receiving cavity.

8. A hand rehabilitation device as claimed in claim 1, wherein a microcontroller monitors the position and torque of said first motor and said second motor.

9. A hand rehabilitation device as claimed in claim 8, wherein sensors are provided to provide torque measurements of said first motor and said second motor, said torque being compared to said torque that is monitored by said microcontroller.

10. A hand rehabilitation device as claimed in claim 1, wherein said hand rehabilitation device is operable in a passive mode or an active mode.

11. A hand rehabilitation apparatus comprising:
a hand rehabilitation device comprising:
a drive mechanism provided in a housing, said drive mechanism comprising a first motor coupled to said housing and a second motor, said first motor and said second motor being independently operable; and
a hand support assembly for receiving a hand of a user, said hand support assembly being coupled to said housing and comprising a first rotatable joint provided between a stationary arm and a first link and a second rotatable joint provided between said first link and a second link, said first link being rotatable about said first rotatable joint by said first motor and said second link being rotatable about said second rotatable joint by said second motor, said second motor being coupled to said first link and rotatable about said first rotatable joint;
a computer in communication with said hand rehabilitation device, said computer including a processor for calculating haptic forces based on a position of said first link and said second link and outputting torques to said hand rehabilitation device, said torques being applied to said first rotating link and said second rotating link by said first motor and said second motor; and
a display in communication with said computer, said display for displaying a visual representation of said hand of said user;
wherein said haptic forces are determined based on a rehabilitation mode.

12. A hand rehabilitation apparatus as claimed in claim 11, wherein said rehabilitation mode is a simulation of a hand grip strength device.

13. A hand rehabilitation apparatus as claimed in claim 12, wherein said hand grip strength device is modeled as a single spring connecting an end of said user's virtual fingers with said user's virtual palm in order to calculate said haptic forces.
